(19) United States
(12) Patent Application Publication
(10) Pub. No.: US 2025/0192534 A1
(43) Pub. Date: Jun. 12, 2025

(54) Dispensing Device for a Flexible Line Arrangement and Line Guide Apparatus with Conveying Unit

(71) Applicant: igus GmbH, Köln (DE)

(72) Inventors: Andreas Hermey, Hennef (DE); Philip Howold, Frechen (DE)

(21) Appl. No.: 18/035,485

(22) PCT Filed: Nov. 8, 2021
(86) PCT No.: PCT/EP2021/080996

§ 371 Date: Jul. 12, 2024

(30) Foreign Application Priority Data
Nov. 6, 2020 (DE) 20 2020 106 401.0

(51) Int. Cl. H02G 11/00; B63B 21/16; B63J 3/04; H02G 3/04

(52) U.S. Cl. CPC H02G 11/003; H02G 11/006; B63B 21/16; B63J 2003/043; H02G 3/0475

(57) ABSTRACT

The invention relates to a pay out apparatus (1) for a spatially deflectable line or line guide device (10) for guiding one or more supply lines (3), comprising a delivery unit (30) for paying out and retracting a longitudinal portion of the line arrangement (2) from a storage region (4). The invention also relates to the delivery unit (30) per se for driving the line guide device (10). According to the invention, the delivery unit (30) comprises a drive wheel (32) which has, on the circumference, a number of engagement portions (33) each having at least one force transmission element (34), and the flexible line arrangement (2) has a plurality of projections (12) and/or recesses on the outside that are distributed along at least one longitudinal portion of the line arrangement (2). The force transmission elements (34) of the drive wheel act force-transmittingly together with a projection (12) and/or recess of the line arrangement (2) to deliver or drive the line guide device (10) during paying out and/or during retraction.

The invention relates to a dispensing device (dispenser) for a flexible line arrangement having at least one supply line, comprising a conveying unit for alternatively dispensing and retracting at least one longitudinal portion of the line arrangement. The invention in particular relates to a dispensing device which is suitable for a spatially deflectable line guide apparatus for guiding at least one supply line.

The invention furthermore generally relates to a conveying unit for a three-dimensionally or spatially deflectable line guide apparatus for guiding one or more supply lines, such as for example cables, hoses or the like, and to such a line guide apparatus which is equipped with a conveying unit.

“Energy guide chains” are one known and proven design of line guide apparatuses for dynamically guiding lines between two points which are mobile relative to one another.

A dispensing device according to the preamble of Claim 1 is already known from WO 2018/091554 A1. This is in particular suitable as a docking device for shore-to-ship power supply. Said document proposes a conveying unit which acts on the deflection arc of an energy guide chain to transmit thrust force or tensile force. The proposed design is, however, complex in terms of construction and maintenance of the device. Furthermore, the design does not appear to be ideally suitable for spatially deflectable line guide apparatuses, i.e. line guide apparatuses which are intended at least in portions to be mobile in three dimensions. Rather, the design from WO 2018/091554 A1 is more suitable for conventional energy guide chains which travel in just one plane.

DE 10 2011 006104 A1 discloses a dispensing device with a supply line as a charging device for electric vehicles. US 2002/043591 A1 relates to a line guide device with supply lines guided therein, wherein the line guide device can be displaced at a movable end relative to a fixed-position end of the line guide device.

It is thus an object of the present invention to propose a dispensing device and in particular a conveying unit for this purpose which is structurally simple and/or can be operated with little maintenance. The conveying unit should be usable both with line guide apparatuses and directly with supply lines (without a line guide apparatus).

According to a first aspect, this object is achieved by a dispensing device having the features according to Claim 1.

Independently thereof, the intention is furthermore to propose a reliable solution for driving three-dimensionally deflectable line guide apparatuses. According to a second aspect, this is achieved by a device with a line guide apparatus and conveying unit having the features according to Claim 2.

According to the invention, the two independent aspects include the core concept that the conveying unit comprises a drive wheel which interacts with the flexible line arrangement. The line arrangement may comprise either a spatially deflectable line guide apparatus optionally with a plurality of guided lines, or merely a suitably configured supply line (without additional line guide apparatus). The term line arrangement is thus understood in the present case to mean both an individual line which is configured to fit the drive wheel and a line guide apparatus which can interact with the drive wheel and guides or can guide one or more lines therein.

The proposed drive wheel can in particular have a number of circumferentially distributed engagement portions, each of which in particular comprises at least one force transmission element or consists of a force transmission element. According to the invention, the flexible line arrangement, on the other hand, comprises a plurality of external projections and/or recesses distributed along at least one sub-length or portion of the line arrangement. These projections and/or recesses interact for force transmission with the drive wheel, in particular with the engagement portions or force transmission elements.

Thus, given a suitable configuration of the line arrangement and with comparatively little additional expenditure, it is possible to apply a robust and simple drive principle similar to a sprocket wheel. This in particular offers the advantage that at least predominantly tensile forces are intended to be exerted on the line arrangement, which means that, in comparison with the application of thrust forces, a longer service life and less wear can be achieved in line guide apparatuses and also in directly driven lines. For interaction, the drive wheel may engage in the line arrangement and/or the line arrangement engages in the drive wheel, depending on the desired configuration.

The projections and/or recesses provided on the outside of the line arrangement may be of any suitable configuration, in particular may form isolated raised or thickened portions and/or take the form of indentations or constrictions. Interspaces which are in any event present on a line guide apparatus may, for example, be utilized as recesses. The terms projections and/or recesses may be understood in general terms. In principle, any other kind of unevenness on the outer surface (viewed in the longitudinal cross-section of the line arrangement) may also be considered. Various designs are also possible for the corresponding configuration of the drive wheel with engagement portions.

The invention generally achieves particular advantages in combination with a spatially deflectable line guide apparatus, i.e. such an apparatus which is intended at least in portions to be three-dimensionally mobile.

A line guide apparatus for guiding the line(s) which may in particular be considered is an “energy guide chain”, in particular an energy guide chain composed of individual links connected together in spatially deflectable manner.

To ensure maximally uniform drive, it is advantageous for the drive wheel to have a plurality of engagement portions which are arranged or distributed over its entire or complete circumference. The engagement portions are preferably uniformly distributed over the entire circumference, i.e. identically spaced in the circumferential direction. The engagement portions may be provided in the radially outer region, but are preferably at least partially shifted inward or recessed relative to the outer radius of the drive wheel, such that guidance in a lateral direction (axially to the direction of rotation) is simplified.

Favorable force ratios are achieved if the force transmission elements of the drive wheel in each case engage with the outside of the line arrangement or line guide apparatus, in particular in form-locking or substantially form-locking manner. It is furthermore advantageous for the force transmission elements to transmit force by striking against the projections and/or recesses in the tangential direction of the drive wheel. As a result, force is transmitted at least predominantly or exclusively in the longitudinal direction of the line arrangement or line guide apparatus such that unfavorable transverse and shear forces are avoided.

The dispensing device may in particular be designed for direct interaction with a power supply cable (without line guide apparatus), wherein the drive wheel interacts directly with the power supply cable for dispensing and retraction. For this purpose, external projections in the form of radially protruding annular regions, annular bodies or the like can be fastened to the outer sheath of the power supply cable. Differently configured projections or indeed indentations may also interact with the one or more force transmission elements.

In a preferred embodiment, the dispensing device is equipped with a three-dimensionally deflectable line guide apparatus which enables protected guidance of one or indeed a plurality of supply lines. In this case, the lines are not directly driven by the drive wheel but the protective line guide apparatus is actuated by the drive wheel such that the line(s) are intrinsically more durable. Various designs of line guide apparatuses may be considered for this purpose.

In a particularly preferred configuration, the line guide apparatus has links which are connected together in articulated manner and can in each case be pivoted or swiveled relative to one another in at least two directions. The links particularly preferably have a circular outer contour in order to enable interaction with the drive wheel which is independent of twisting about its own longitudinal axis.

When using a line guide apparatus with links connected in articulated manner, the links are arranged one behind the other in the longitudinal direction and preferably form a guide channel for the lines by way of radially external guide parts. The guide parts may be substantially annular in form and are preferably circumferentially closed or preferably circumferentially completely enclose the guide parts such that radial forces on the drive wheel are better absorbed. The articulated connections provided between the links may in particular take the form of ball joints so as to enable spatial deflection or swiveling of the links relative to one another in each spatial direction.

A configuration with a tubularly closed line guide apparatus or energy guide chain such that the lines are guided in such a manner that they are protected against external influences is particularly preferred. To this end, the guide parts of successive links may form a tubular sheath closed in the longitudinal direction and circumferential direction. Other continuous, flexible envelopes, for example in the form of a corrugated hose (without pronounced links) or a “hose package”, are also conceivable as a line guide apparatus.

For interaction with the drive wheel, such a closed sheath is preferably provided with external projections, in particular in the form of radially protruding annular regions, annular bodies or the like. Annular circumferential regions permit interaction with the force transmission elements, in which twisting about the longitudinal axis is immaterial. The annular regions or annular bodies may here have any suitable cross-sectional shape.

In a preferred further development, annular bodies for interaction with the force transmission elements are fastened as separate attachments to the sheath of the line guide apparatus in force-locking and/or form-locking manner, in particular stationarily in the axial direction on the line guide apparatus. The annular bodies are preferably fastened in force-locking manner, for example by threaded connections. This permits inter alia the use of existing spatially deflectable line guide apparatuses.

Known and in principle suitable designs of spatially deflectable line guide apparatuses have been proposed for example in WO 2004/093279 A1 or WO 2010/119083 A2.

It is, however, likewise possible to use specially configured links which have projections formed on the sheath or made in one-piece therewith or with external guide parts. Line guide apparatuses may furthermore also be used which by virtue of their structure already have indentations between the individual links, as for example in the design according to WO 2019/243377 A1.

It is in principle advantageous for a plurality of circumferentially distributed force transmission elements to be provided on the drive wheel, as this enables operation without imbalance or with good concentricity.

In one embodiment, each force transmission element may for example be a U-shaped stirrup with a receptacle corresponding to the external diameter of the line or line guide apparatus. In particular in this design it is advantageous for the drive wheel to comprise two opposing wheel disks between which the force transmission elements are fastened. The wheel disks may at the same time form a lateral guide for the line or line guide apparatus.

External projections are in principle preferably provided on the line arrangement for interaction with the drive wheel. The projections here preferably take the form of completely circumferential beads or thickened portions or circumferential annular regions cross-sectionally perpendicular to the longitudinal direction.

The external projections or recesses on the line arrangement, for example suitable annular bodies, preferably have an outer face or contour which is symmetrical in cross-section to a central plane perpendicular to the longitudinal direction of the line arrangement or perpendicular to the axis of the annular body. Corresponding symmetry permits conveying equally in both directions, forward and backward, or dispensing and retraction by suitable elements of the drive wheel being capable of engaging, depending on the direction of rotation, on both sides with the projections or recesses. The projections, in particular annular bodies, for example in section through the longitudinal axis, may for example have an approximately semicircular cross-section such that interfering edges are also avoided.

For smooth or jerk-free running, it is advantageous for the projections or recesses to be distributed with uniform longitudinal spacing along the longitudinal direction on the line or line guide apparatus. Thus, preferably over at least one longitudinal portion of the line arrangement, the spacing between every two successive projections or recesses is identical in each case.

For maximally reliable and jerk-free engagement on the drive wheel, the spacing in the radian measure between successive force transmission elements is preferably distinctly greater than the longitudinal spacing (for example center-to-center distance) between every two successive projections and/or recesses. Particularly preferably, the spacing in the radian measure between a first and a third force transmission element or a first and a fourth force transmission element in the sequence of the circumferential direction corresponds to the preferably respective uniform or identical longitudinal spacing between the counterparts on the line arrangement, i.e. the projections or recesses. Simultaneous and thus gentler introduction of force can be achieved at at least two points on the line guide apparatus, wherein at the same time an engagement tolerance (for example by the arc distance of the force transmission elements) is provided.

In order to prevent slippage from the drive wheel or to keep the line arrangement in engagement with the drive wheel, an arcuate retaining face is advantageously provided on the conveying unit, which is arranged at a suitable radial distance relative to the drive wheel and extends over a partial circumference of the drive wheel along the latter. The radian measure is here preferably distinctly less than 120°, in particular less than 90°.

Depending on the intended application, the line arrangement or the line guide apparatus can have a free end, in particular with a supply connector, for instance for connection alternatively to a consumer or to a supply source. Correspondingly, the line or line guide apparatus may have a stationary end which is in particular permanently fixed to a connection point.

For the use of spatially deflectable line guide apparatuses, it is advantageous for the conveying unit to have on the output side a guide device, preferably a for example funnel-like insertion device, which directs the line arrangement (i.e. the line guide apparatus or alternatively the directly driven supply line) onto the drive wheel on retraction. This enables reliable or very largely automatic retraction or retrieval of the line arrangement regardless of its position relative to the drive wheel.

In a preferred embodiment, the guide device which directs the line arrangement onto the drive wheel is fitted or mounted to be movably adjustable or alignable, in particular swivelable about at least one axis. The guide device may to this end be provided on a swivel arm which may optionally have its own drive for adjustment in order to set the dispensing direction or receiving direction. The guide device may here be mounted, for example on the frame supporting the drive wheel, so that it can swivel at least about the axis of rotation of the drive wheel and/or be arranged so that it can swivel over a predetermined angular range of preferably at 45°. This makes it possible to dispense the line arrangement, for example in relation to the frame, alternatively in different positions or in various directions, for example at any desired inclination from virtually perpendicularly downward to virtually horizontally sideways, and conversely retract it therefrom.

Depending on the application, in the retracted state the line arrangement can hang freely between the drive wheel and connection point or for example be wound onto a drum.

In principle, any suitable drive motor can be operatively connected to the drive wheel. Furthermore, any suitable design of a frame for the drive wheel may be provided on which the drive wheel is mounted for rotation about an axis of rotation. The drive motor for driving the drive wheel in rotation can accordingly be attached to the frame. A vertical upright or beam, at the upper end of which the drive wheel is provided, and opposite which the line arrangement is stored in a freely suspended manner may be considered as a stationary frame.

In an advantageous further development, the drive motor of the drive wheel is connected to a limit switch device which switches off the drive motor once a predetermined end position is reached, in particular when the line arrangement is fully dispensed or drawn in. The limit switch device is designed to interact with a detection element on the line arrangement, for example an annular body specially configured for this purpose on the line guide apparatus, in order to switch off the drive motor in the end position on dispensing and/or in the end position on retraction. The limit switch device may interact mechanically by contact with the detection element, for example in the manner of a limit switch which is actuated on striking the detection element, or also contactlessly, for example magnetically or the like. In this way, automatic switching off in a predetermined end position can be straightforwardly achieved by appropriate arrangement of one or two detection element(s) at the desired position of the line arrangement.

In principle, the frame may have any kind of storage space for receiving the retracted longitudinal portion of the line arrangement, in particular also an enclosure or housing which forms the storage space. The drive wheel is structurally conveniently arranged on the frame on the output side of the storage space.

The proposed dispensing device is suitable in particular but not exclusively for supplying power to mobile or variable consumers. The dispensing device is suitable in particular for shore-to-ship power supply, in a similar way as proposed in WO 2018/091554 A1.

The proposed conveying unit is, however, also particularly advantageously usable in other applications in combination with spatially deflectable, flexible line guide apparatuses, for example in a rewinding device, in combination with a winding drum or reel, etc.

The combination of conveying unit and line guide apparatus offers inter alia the advantage of guiding one or more lines in protected manner without the conveying unit having to engage directly with the lines, i.e. without transmitting tensile forces directly to the lines.

The invention is usable for any kind of supply lines, such as cables, hoses or the like, in particular for power supply lines with comparatively large diameter or large weight per unit length, for instance high-current lines and/or lines for shore-to-ship power supply.

Further details, features and advantages of the invention are revealed by the following, detailed description of preferred embodiments made with reference to the appended figures, in which:

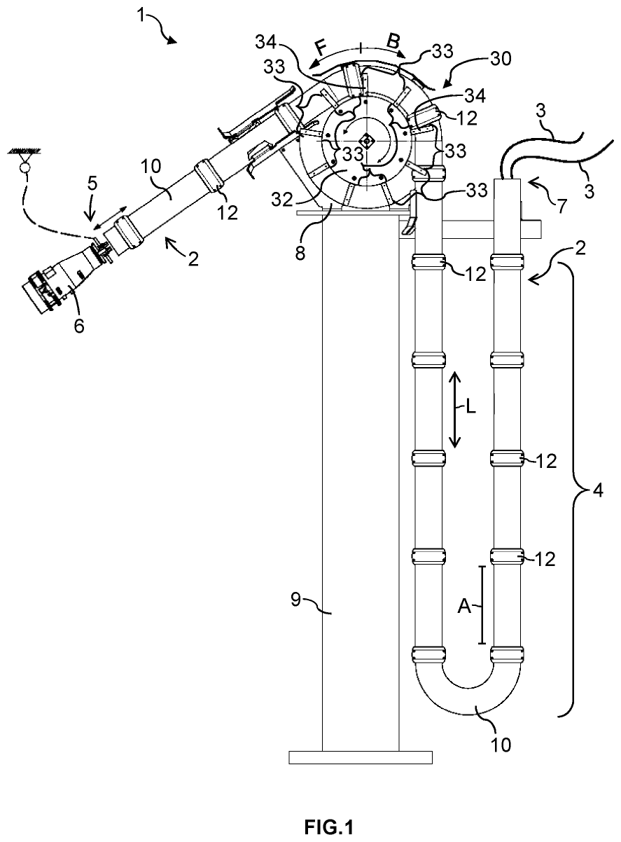

FIG. 1 is a schematic side view of a dispensing device with a line guide apparatus and a conveying unit according to a first exemplary embodiment;

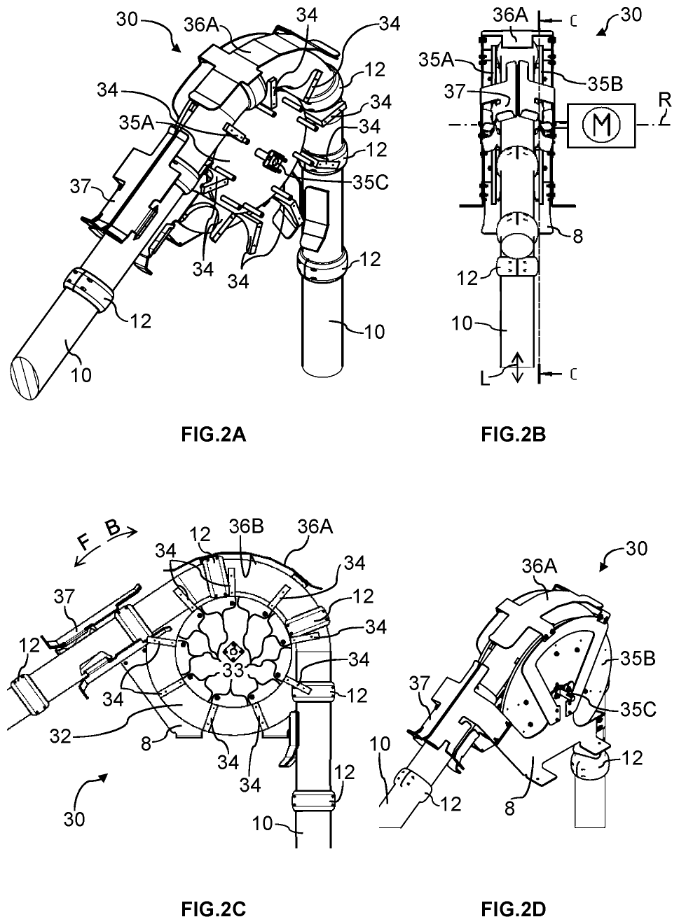

FIG. 2A-FIG. 2D are views of a conveying unit, for example for use in the device according to FIG. 1, in partially cutaway perspective view (FIG. 2A); in front view (FIG. 2B); in the longitudinal section along section line C-C from FIG. 2B (FIG. 2C) and in closed perspective view (FIG. 2D);

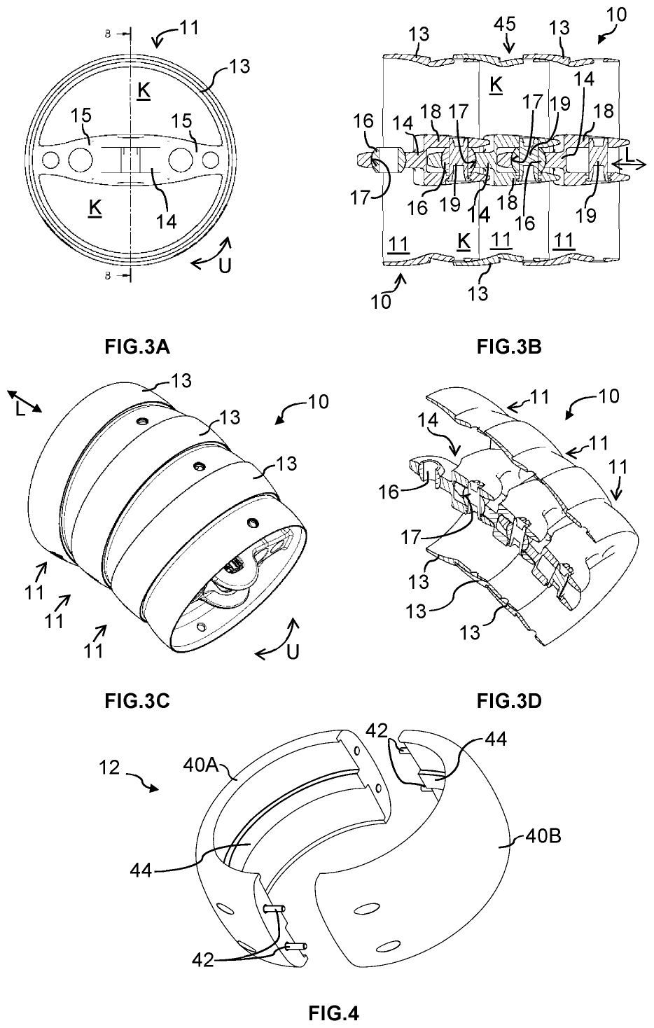

FIGS. 3A-3D are views of a plurality of links of a preferred line guide apparatus for use with a conveying unit according to FIGS. 2A-2D, in front view (FIG. 3A), in longitudinal section (FIG. 3B), in perspective external view (FIG. 3C) and in perspective longitudinal section (FIG. 3D);

FIG. 4 is a perspective view of a two-part annular body which is suitable as a separate attachment for retrofitting a line guide apparatus according to FIGS. 3A-3D so that the latter can be driven by the conveying unit according to FIGS. 2A-2D;

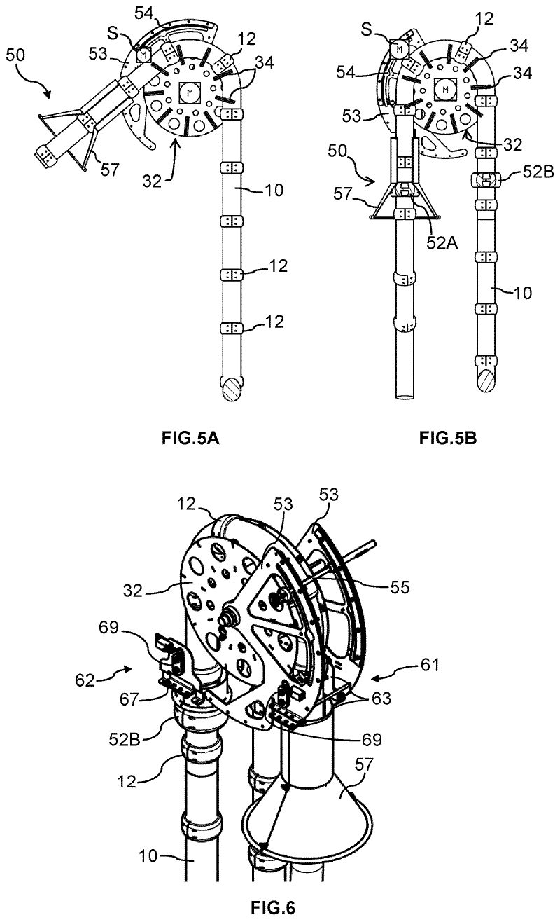

FIGS. 5A-5B and FIG. 6 show a second exemplary embodiment of a dispensing device with a line guide apparatus and a conveying unit in section through the vertical central plane (FIG. 5A-FIG. 5B), with a guide device swivelable between various positions which directs the line arrangement or line guide apparatus onto the drive wheel on retraction and with a limit switch device for the drive of the conveying unit, in perspective view (FIG. 6).

FIG. 1 shows a dispensing device, denoted 1 overall, for a flexible line arrangement 2 with a spatially deflectable line guide apparatus 10 which guides a plurality of supply lines 3, for example electrical lines for power supply, from a stationary end 7 or fixed point to a free end 5. The line guide apparatus 10 protects the lines 3 in the resting state and when in motion, i.e. on dispensing and retraction. At the free end of the line arrangement 2, the supply lines 3 are connected to a supply connector 6, for example for shore-to-ship power supply (not shown).

The dispensing device 1 comprises a storage space 4 from which a desired length of the line arrangement 2 is dispensed and into which the latter is retracted again. In the example shown, the line arrangement 2 is freely suspended as a loop in the storage space 4. Rolling onto a drum or other forms of storage are within the scope of the invention. The storage space 4 may be provided in a protective enclosure or in a housing of suitable design (not shown).

The dispensing device 1 comprises a conveying unit 30 for mechanically conveying or driving the line arrangement 2 on dispensing from and retraction back into the storage space 4. The conveying unit 30 comprises a drive wheel 32 which forms a number of engagement portions 33 on its circumference, in this case for example with nine engagement portions 33. The number N of engagement portions 33 should be selected to suit the diameter and flexibility of line arrangement 2 and should comprise at least two and preferably a plurality of engagement portions 33, for example in the range from 6≤N≤12. The line arrangement 2 interacts with the engagement portions 33 for force transmission such that, depending on the direction of rotation of the drive wheel 32, the line arrangement 2 is moved forward or backward in the forward direction F or backward direction B.

In FIG. 1, the flexible line arrangement 2 has a plurality of external projections, in the form of annular bodies 12, which are provided externally on the line guide apparatus 10. These projections or annular bodies 12 are distributed along at least one longitudinal portion which is to be driven of the line arrangement 2, preferably with in each case identical longitudinal spacing A in the longitudinal direction L. The radially protruding annular bodies 12 on the line arrangement 2 interact with force transmission elements 34 in the engagement portions 33 of the drive wheel 32. In the example from FIGS. 1-2, each engagement portion 33 has exactly one assigned force transmission element 34 which is appropriately conjugately configured for engagement with a projection or annular body 12.

In FIG. 1, the conveying unit 30 comprises a frame 8 which is supported by a vertical upright 9 such that the drive wheel 32 is arranged on the frame 8 on the outlet side or above the storage space 4. Thus, both in the forward direction F and in the backward direction B, tensile force is in each case primarily transmitted to the line arrangement 2 by the drive wheel 32. As intended, tensile force is readily absorbed by the line guide apparatus 10 and introduced via the annular bodies 12. In addition, no undesirable load is applied to the supply lines 3, which are protected by strain relief at the end in the line guide apparatus 10.

A preferred embodiment of the conveying unit 30 is explained in greater detail with reference to FIG. 2A-FIG. 2D. The conveying unit 30 is intended and configured to drive a line guide apparatus 10. The conveying unit 30 is not limited to use in a dispensing device as for example in FIG. 1, but may advantageously also be put to use elsewhere for mechanically actuating or moving corresponding line guide apparatuses 10.

On the drive wheel 32, a plurality of engagement portions 33 are uniformly distributed around the entire circumference, each of which in the present case has precisely one force transmission element 34 (FIG. 2C). Each force transmission element 34 is configured in FIG. 2A-FIG. 2D as a U-shaped stirrup with a receptacle. The receptacle in the stirrup 34 is open axially on both sides and open radially outwardly and is configured to correspond to a circular outer contour of the line guide apparatus 10 (cf. FIG. 2A). The U-shaped stirrups 34 have an approximately semicircular free cross-section such that they can encompass at least half the circumference of the line guide apparatus 10. The force transmission elements 34 are circumferentially distributed with in each case a maximally identical radian measure, here of approximately 40°, such that, on engagement of the line guide apparatus 10, force can be transmitted to the annular bodies 12 thereof, in any rotational position. FIG. 2C shows that, for more favorable force distribution, two force transmission elements 34 engage simultaneously with a first annular body 12 and the next but one annular body 12. The radian measure between the force transmission elements 34 here corresponds to half the longitudinal spacing A such that a smaller angle of rotation is required to achieve engagement. The force transmission elements 34 are fastened, e.g. bolted, between two opposing wheel disks 35A, 35B of the drive wheel 32. The dimension of the force transmission elements 34 in the circumferential direction may be comparatively short, as shown in FIGS. 2A-2D, or extend arcuately over a larger angle, and for example form a larger bearing face for the line guide apparatus 10 to provide radial support. The axial dimension of the stirrups or force transmission elements 34 parallel to the axis of rotation R is slightly greater than the external diameter of the projections or annular bodies 12. The wheel disks 35A, 35B accordingly simultaneously provide lateral guidance for the line guide apparatus 10 transverse to the longitudinal direction L thereof (cf. FIG. 2B). A drive shaft 35C is fastened non-rotatably to the two wheel disks 35A, 35B and coupled with a drive/motor M, for example an electrical servomotor (FIG. 2B). The drive wheel 32 is mounted for rotation about the axis of rotation R by way of the drive shaft 35C.

The force transmission elements 34 of the drive wheel 32 interact for force transmission with corresponding counterparts on the line guide apparatus 10, in this case with the projections or annular bodies 12, in order to actuate or move the line guide apparatus 10 alternatively in the forward direction F or the backward direction B. Instead of or in addition to projections 12, the line guide apparatus 10 may also have recesses or cutouts (not shown) with which correspondingly matching elements of the engagement portions 33 interact. The diameter of the drive wheel 32 or the effective radius on the inside of the force transmission elements 34 is adapted to the admissible radius of curvature of the line guide apparatus 10 and is preferably selected to be at least slightly larger in order to reduce loads.

FIGS. 2A-2D furthermore show an exemplary design of the frame 8, on which the drive wheel 32 with its drive shaft 35C is mounted for rotation. The frame 8 comprises a formed retaining plate 36A which is spaced radially externally from the drive wheel 32. The retaining plate 36A forms a roughly arcuate retaining face 36B which is radially spaced relative to the drive wheel 32, wherein the spacing is selected such that the annular bodies 12 pass through with little clearance. The retaining plate 36A with the retaining face 36B extends over a partial circumference of the drive wheel 32, in this case over approximately 60°-80° in the radian measure. The retaining face 36B keeps the line guide apparatus 10 constantly engaged on the drive wheel 32. Advantageously, in a line guide apparatus 10 with a free end 5 which can be moved in all spatial directions as required, a funnel-like insertion device 37 is attached to the frame 8 on the output side in the forward direction F. The insertion device 37, for example made of formed sheet metal parts, tapers in funnel-like manner in the backward direction B and is directed tangentially to the drive wheel 32 such that the line guide apparatus 10 is guided into engagement on the drive wheel 32, regardless of the spatial position of the free end 5.

FIGS. 3A-3D show a particularly preferred design of a line guide apparatus 10 which is made up of individual, identically constructed links 11 with a circular outer contour (FIG. 3A) which are connected together in articulated manner. FIGS. 3B-3D show only a sub-portion of three links. The links 11 are linked one behind the other or in succession in the longitudinal direction and, by way of radially external guide parts 13, form at least one guide channel K for lines 3, and for this purpose are connected via bars with central parts 14. Two adjacent links 11 can in each case be swiveled spatially relative to one another about three orthogonal axes. The links 11 are to this end connected together via articulated joints. The links 11 have central parts 14, each having on both ends in the longitudinal direction L ball joints made up of a ball joint head 16 and a ball joint socket 17. In FIGS. 3A-3D, each ball joint head 16 is provided as a separate joint ball which is retained in a ball joint socket 17 at one end of the central part 14. At the other end of the central part 14, a joint yoke 18 is provided which has radially opposing passage openings for a securing pin 19 with which the joint ball of the ball joint head 16 is secured. The securing pin 19 is in each case perpendicular to the longitudinal direction L and permits the transfer of considerable tensile forces in the longitudinal direction L through the ball joint 16, 17. The securing pins 19 are inserted and removed by way of access openings 19A which are provided in the otherwise circumferentially closed external guide part 13 of each link 11. As FIG. 3C shows, the guide parts 13 and successive links 11 form interdigitated domed portions and, overall, a tubular sheath which is closed in the longitudinal direction L and circumferential direction U, which is thus robust and well suited to absorbing forces. The links 11 are manufactured from plastics, for example as injection moldings.

Projections for interaction with the drive wheel 32 can be produced on a line guide apparatus 10 by retrofitting suitable annular bodies 12 as separate attachments.

FIG. 4 shows a preferred example of an annular body 12 which consists substantially of two semiannular, preferably identically constructed shell parts 40A, 40B which are connected together by bolts 42 and force-lockingly clamped at the outer circumference against the guide parts 13. The shell parts 40A, 40B have a circular ring-shaped outer contour which is rounded at the end face and, in the connected state, closed around the longitudinal direction L. The shell parts 40A, 40B are mirror-symmetrical relative to a central plane perpendicular to the longitudinal axis L. On the inside, the annular bodies 12 or shell parts 40A, 40B form a retaining projection 44 which engages in a circumferential groove 45 on the outer circumference between interdigitated guide parts 13 of two linearly oriented and connected together links 11 (cf. FIG. 3B) in order to secure the annular bodies 12 in the longitudinal direction L fixedly on the line guide apparatus 10. The annular bodies 12 may in each case be fixed to a pair of successive links 11 and optionally reduce or block their ability to swivel. A circumferentially closed annular body 12 promotes uniform introduction of force through the drive wheel 32. As is apparent in FIG. 1, annular bodies 12 of shell parts 40A, 40B are preferably not provided on every link 11, but instead on every n^{th} link 11 or every n^{th} pair of two links 11, preferably with n≥2, in particular with n≥3. A constant spacing A is thus inherently achieved and simple manufacture enabled.

Retrofittable separate annular bodies 12 according to the principle of FIG. 4 permit inter alia the use of a known line guide apparatus which is primarily intended and suitable for other applications, even without a drive wheel 32.

FIGS. 5A-5B and FIG. 6 show a further development according to a second exemplary embodiment which is based on the principle of FIGS. 1-4 with regard to its basic structure, i.e. it comprises a conveying unit with a drive wheel 32 which has on its circumference a number of engagement portions 33 with in each case at least one force transmission element 34 which interact with annular bodies 12 on the line guide apparatus 10 in order to drive the latter alternatively in the forward direction F or the backward direction B. Equivalent parts are therefore not described again with regard to function and/or design.

The substantial difference from the previous exemplary embodiment consists in two additional functions, namely on the one hand an adjustable guide device 50 and on the other hand a limit switch device 61, 62, which switches off the drive/motor M of the drive wheel in both end positions on dispensing and/or retraction of the line guide apparatus 10.

The adjustable guide device 50 is freely adjustable about a swivel axis coaxial to the axis of rotation R (=axis of drive/motor M) between an approximately vertical position (FIG. 5B) and a raised (cf. FIG. 5A), for example also horizontal position (not shown) and has its own actuator S for this purpose. Here, as in FIGS. 1-4, the swivelable guide device 50 has a funnel-like insertion orifice 57 in the manner of a coupling mouth in order to guide or direct the line guide apparatus 10 onto the drive wheel 32. However, in FIGS. 5A-5B and FIG. 6, the funnel-like insertion orifice 57 is installed on two arcuate lateral carriers 53 which are swivelably mounted about the axis R and have a cam groove 54 in which a shaft 55 of the actuator S engages for motor-driven adjustment of the dispensing direction of the guide device 50. In this way, possible distances for removal of the line guide apparatus 10 can be bridged, or a more suitable feed in height terms can be set variably or as required, for instance in the case of shore power supply.

Finally, a preferred limit switch device 61, 62 for switching off the drive/motor M on retraction or dispensing will be explained with reference to FIGS. 5A-5B and FIG. 6. The insertion orifice 57 is displaceably guided by a tubular extension with a switching flange 63 into a slotted link on the two carriers 52, for instance in a direction tangential to the drive wheel 32. A first limit switch device 61 for switching off in the maximum end position on retraction (on the right in FIG. 6), i.e. when the line guide apparatus 10 is fully retracted, has a limit switch 65 which is actuatable by the switching flange 63 guided in the slotted link. A limit switch 65 for controlling the drive/motor M is actuated by way of the switching flange 63. To this end, on retraction, a special switching annular body 52A (FIG. 5B) with a larger external diameter than the driving annular bodies 12 strikes against the inside of the insertion orifice 57 and so draws the switching flange 63 against the retraction limit switch 65 in order to actuate the latter in this fully drawn in end position.

The limit switch device 62 for dispensing is implemented with a similar design. To this end, a further switching flange 67 is displaceably, for instance tangentially, guided in a slotted link on the opposite end of the conveying unit 30 and interacts with a limit switch 69 when a special switching annular body 52B draws the switching flange 67 against the dispensing limit switch 69. The switching annular body 52B is attached to the line guide apparatus 10 in accordance with the fully dispensed position.

Thanks to this simple and robust design, the limit switch device 61, 62 can be adjusted manually and purely mechanically with regard to the desired end position during on-site assembly by selectively attaching special switching annular bodies 52A, 52B to the line guide apparatus 10. The special switching annular bodies 52A, 52B serve as mechanical detection elements for detecting the position of the line guide apparatus 10. The switching annular bodies 52A, 52B may here, apart from the larger diameter, be of a similar design to FIG. 4 and be detachably attached to the line guide apparatus 10. As an alternative to the mechanical limit switch device 61, 62 shown, other contactless, for example electromechanical solutions may also be used.

### LIST OF REFERENCE SIGNS

1 Dispensing device
2 Line arrangement
3 Supply line
4 Storage space
5 Free end
6 Supply connector
7 Stationary end (fixed point)
8 Frame
9 Upright
10 Line guide apparatus
11 Links
12 Annular bodies
13 Guide parts
14 Central part
15 Bar
16 Ball joint head
17 Ball joint socket
18 Joint yoke
19 Securing pin
30 Conveying unit
32 Drive wheel
33 Engagement portions
34 Force transmission element
35A, 35B Wheel disk
35C Drive shaft
36A Retaining plate
36 Retaining face
37 Insertion device
40A, 40B Shell parts
42 Bolts
44 Retaining projection
50 Groove
50 Guide device
52A, 52B Switching annular bodies
53 Carrier
54 Cam groove
55 Shaft (of the actuator S)
57 Insertion orifice
61, 62 Limit switch device
63, 67 Switching flange
65, 69 Limit switch
A Longitudinal spacing
B Backward direction
F Forward direction
K Channel
L Longitudinal direction (of the line guide apparatus)
M Drive/motor (of the drive wheel)
R Axis of rotation (of the drive wheel)
S Actuator (of the guide device 50)
U Circumferential direction

1. A dispensing device (1) with a flexible line arrangement (2) comprising a line guide apparatus (10) for guiding one or more supply lines (3), wherein the line guide apparatus has links (11) which are connected together in articulated manner and can be pivoted relative one another, the dispensing device (1) comprising a conveying unit (30) for dispensing at least one longitudinal portion of the line arrangement (2) from a storage space (4), the conveying unit (30) incudes a drive wheel (32) which has on its circumference a number of engagement portions (33) with in each case at least one force transmission element (34);
wherein the flexible line arrangement (2) has a plurality of external projections (12) and/or recesses which are distributed along at least one longitudinal portion of the line arrangement (2); and
each force transmission element (34) of the drive wheel is configured to interact for force transmission with a projection (12) and/or recess of the line arrangement (2) in order to convey or drive the line arrangement (2) on dispensing and/or retraction.

2. A device with a three-dimensionally deflectable line guide apparatus (10) which has links (11), which are connected together in articulated manner and can in each case be pivoted relative to one another in at least two directions, for guiding one or more supply lines (3), and with a conveying unit (30) for driving the line guide apparatus (10),
wherein the conveying unit (30) comprises a drive wheel (32) which has on its circumference a number of engagement portions (33) with in each case at least one force transmission element (34);
wherein the line guide apparatus (10) has a plurality of external projections (12) and/or recesses which are distributed along at least one longitudinal portion of the line guide apparatus (10); and
wherein each force transmission element (34) of the drive wheel (32) is configured to interact for force transmission with a projection (12) and/or recess of the line guide apparatus (10).

3. The device according to claim 1, wherein the drive wheel (32) has a plurality of engagement portions (33) over a circumference of the drive wheel, engagement portions (33) are uniformly distributed over the circumference of the drive wheel.

4. The device according to claim 3, wherein
the force transmission elements (34) of the drive wheel in each case engage in form-locking manner with the outside of the line arrangement (2) or line guide apparatus (10) and/or, by striking the force transmission elements (34) in the tangential direction of the drive wheel (32), transmit force to the line arrangement or line guide apparatus in the longitudinal direction (L) thereof.

5. The device according to claim 2, wherein the links (11) have a circular outer contour, are arranged one behind the other in the longitudinal direction and form at least one guide channel by way of radially external guide parts (13), wherein articulated joints (16, 17) are arranged between links (11) which are connected together in articulated manner, and wherein the guide parts (13) are preferably annularly circumferentially closed.

6. The device according to claim 5, wherein
the guide parts (13) of successive links (11) form a tubular sheath closed in the longitudinal direction (L) and circumferential direction (U) and in that the sheath has external projections.

7. The device according to claim 6, wherein
the annular bodies (12) are fastened in force-locking and/or form-locking manner as separate attachments to the sheath.

8. The device according to claim 1, wherein a plurality of force transmission elements (34) are provided and each force transmission element takes the form of a U-shaped stirrup (34) with a receptacle corresponding to the external diameter of the line arrangement or line guide apparatus (10), wherein the drive wheel (32) has two opposing wheel disks (35A, 35B) between which the force transmission elements (34) are fastened and which form a guide for the line arrangement or line guide apparatus (10).

9. The device according to claim 1, wherein
the external projections (12) take the form of completely circumferential beads or thickened portions extending around the longitudinal direction (L); and/or
the projections or recesses are distributed with uniform spacing (A) along the longitudinal direction (L).

10. The device according to claim 1, wherein the conveying unit (30) has an arcuate retaining face (36B) which is arranged radially spaced relative to the drive wheel (32) and extends over a partial circumference of the drive wheel.

11. The device according to claim 1, wherein the line arrangement or line guide apparatus (10) has a free end (5), in particular with a supply connector (6), and a stationary end (7); and/or
wherein the conveying unit (30) has a guide device on the output side which directs the line arrangement or line guide apparatus (10) onto the drive wheel (32) on retraction,
wherein the guide device is preferably configured as a funnel-like insertion device (37); and/or the guide device (50) is arranged movably adjustably.

12. The device according to claim 1, further comprising a drive motor (M) s operatively connected to the drive wheel (32) and/or a stationary frame (8) is provided on which the drive wheel (32) is mounted for rotation about an axis of rotation (R), wherein the drive motor (M) for driving the drive wheel (32) in rotation is fastened to the frame (8).

13. The device according to claim 12, wherein the drive motor (M) of the drive wheel (32) is connected to a limit switch device (61, 62) which interacts with a detection element (52A, 52B) on the line arrangement or on the line guide apparatus (10) in order to switch off the drive motor (M) in the end position on dispensing and/or in the end position on retraction.

14. The device according to claim 12, wherein the frame (8) has a storage space (4) for receiving a retracted longitudinal portion of the line arrangement, wherein the drive wheel (32) is arranged on the frame (8) on the output side of the storage space (4).

15. Use of the dispensing device (1) according to claim 1 for supplying power to a mobile consumer, in particular for shore-to-ship power supply.

16. The device according to claim 5, wherein the guide parts (13) of successive links (11) form a tubular sheath closed in the longitudinal direction (L) and circumferential direction (U) and in that the sheath has external projections formed as radially protruding annular regions or annular bodies (12) which interact with the force transmission element(s) (34).

17. The device according to claim 2, wherein a plurality of force transmission elements (34) are provided and each force transmission element takes the form of a U-shaped stirrup (34) with a receptacle corresponding to the external diameter of the line arrangement or line guide apparatus (10), wherein the drive wheel (32) has two opposing wheel disks (35A, 35B) between which the force transmission elements (34) are fastened and which form a guide for the line arrangement or line guide apparatus (10).

18. The device according to claim 2, wherein
the external projections (12) take the form of completely circumferential beads or thickened portions extending around the longitudinal direction (L); and/or
the projections or recesses are distributed with uniform spacing (A) along the longitudinal direction (L).

19. The device according to claim 2, wherein the conveying unit (30) has an arcuate retaining face (36B) which is arranged radially spaced relative to the drive wheel (32) and extends over a partial circumference of the drive wheel.

20. The device according to claim 2, further comprising a drive motor (M) operatively connected to the drive wheel (32) and/or a stationary frame (8) is provided on which the drive wheel (32) is mounted for rotation about an axis of rotation (R), wherein the drive motor (M) for driving the drive wheel (32) in rotation is fastened to the frame (8).
